(19) United States
(12) Patent Application Publication
(10) Pub. No.: US 2026/0360914 A1
(43) Pub. Date: Nov. 12, 2026

(54) POWER SUPPLY DEVICE

(71) Applicant: Panasonic Intellectual Property Management Co., Ltd., Osaka (JP)

(72) Inventor: HIDEMI KURIHARA, Osaka (JP)

(21) Appl. No.: 19/515,843

(22) PCT Filed: Sep. 5, 2024
(86) PCT No.: PCT/JP2024/031843

§ 371 Date: Mar. 3, 2026

(30) Foreign Application Priority Data
Sep. 13, 2023 (JP) 2023-148112

(51) Int. Cl. H01M 50/325

(52) U.S. Cl. CPC H01M 50/325

(57) ABSTRACT

A power supply device (100) includes an exterior case (10) including a gas outlet (13) partially opened therein, a lid (30) closing the gas outlet (13), and an annular elastic body (40) interposed between a periphery of the gas outlet (13) and the lid (30). The exterior case (10) includes an elastic holding portion (26) holding the elastic body (40) and a locking piece (20) locking the lid (30) around the gas outlet (13). The lid (30) forms a step section (32) engaging with the locking piece (20). The lid (30), by engagement between the step section (32) and the locking piece (20), presses the elastic body (40) to elastically deform the elastic body (40), thereby closing the gas outlet (13) in a waterproof state. When gas is discharged from the gas exhaust valve (1a), the lid (30) is pressed from the inner surface side of the gas outlet (13) due to an increase in the internal pressure of the exterior case (10), and the engagement between the step section (32) and the locking piece (20) is released.

### TECHNICAL FIELD

The present disclosure relates to a power supply device.

### BACKGROUND ART

A power supply device that houses a rechargeable secondary battery cell such as a lithium-ion secondary battery inside an exterior case and drives an electrical device is used (for example, Patent Literature 1). Some of such power supply devices have a waterproof structure because an unintended short circuit may occur when water enters the exterior case.

On the other hand, when any abnormality occurs in the secondary battery cell and high-pressure gas is generated inside the outer can, the gas exhaust valve provided on the outer can is configured to be opened. At this time, a structure for discharging, from the exterior case to the outside, the high-pressure gas released into the exterior case is required.

As described above, the power supply device is required to have a configuration capable of discharging high-pressure gas from the inside of the exterior case while maintaining waterproofness with respect to the outside of the exterior case. Conventionally, a structure has been adopted in which a gas outlet formed in the exterior case is closed by attaching a waterproof label with an adhesive or double-sided tape. With this configuration, it is possible to maintain waterproofness with the waterproof label with respect to the outside, and at the time of operation of the gas exhaust valve, the high-pressure gas presses, from the inner surface, the waterproof label closing the gas outlet to peel off the attached label and break the closed state.

However, when a waterproof label is attached with an adhesive, it is necessary to increase the adhesive area in order to maintain waterproofness. On the other hand, in order to reliably peel off the waterproof label during operation of the gas exhaust valve, it is conversely necessary to reduce the adhesive area. Actually, this adjustment is not easy because the rate of increase of the pressure inside the exterior case varies depending on the volume of the exterior case, the capacity of the secondary battery cell, and the like. In addition, when the operating time of the gas exhaust valve is long, if the exterior case is made of resin, the exterior case may be damaged, and high-pressure gas may flow out from an unintended portion and ignite, leading to a leakage fire. Further, in the case of manually attaching the waterproof label, there are uncertain factors such that the adhesion, that is, the waterproofness depends on the attaching operation. As described above, it is difficult to achieve both the maintenance of waterproofness and the guarantee of the valve opening operation at the time of gas discharge, because conflicting characteristics are required.

### CITATION LIST

### Patent Literature

Patent Literature 1: Japanese Patent Publication WO20/153017

### SUMMARY OF THE INVENTION

An object of the present disclosure is to provide a power supply device that achieves both waterproofness of the exterior case and gas discharge performance of the exterior case. Another object of the present disclosure is to provide a power supply device with improved reliability. Note that the description of these objects and problems does not preclude the existence of other objects and problems. Further, one embodiment of the present disclosure does not necessarily need to solve all of these problems. Furthermore, it is possible to extract other problems from the description of the specification, drawings, and claims of the present disclosure.

A power supply device according to one aspect of the present disclosure includes: a plurality of secondary battery cells each including a gas exhaust valve configured to open in response to an increase in internal pressure; an exterior case which accommodates the plurality of secondary battery cells in the exterior case and includes a gas outlet opened for discharging gas released from the gas exhaust valve to outside of the exterior case; a lid closing the gas outlet; and an annular elastic body interposed between a periphery of the gas outlet and the lid, wherein the exterior case includes, an elastic holding portion holding the annular elastic body around the gas outlet, and at least one locking piece locking the lid, the lid forms a step section engaging with the at least one locking piece, the lid, by engagement between the step section and the at least one locking piece, presses the annular elastic body to elastically deform the annular elastic body and close the gas outlet in a waterproof state, and when gas is discharged from the gas exhaust valve, the lid is pressed from an inner surface of the gas outlet by an increase in internal pressure in the exterior case, and the engagement between the step section and the at least one locking piece is released.

The power supply device according to one aspect of the present disclosure exhibits a waterproof structure of the gas outlet by elastic deformation of the elastic body. In addition, when high-pressure gas is discharged from the gas exhaust valve and the internal pressure in the exterior case of the power supply device increases, the engagement between the exterior case and the lid can be released, and high-pressure gas can be discharged from the exterior case to the outside through the gas outlet. The power supply device can improve the reliability of both the waterproof function and the gas discharge function while achieving both functions.

### BRIEF DESCRIPTION OF THE DRAWINGS

FIG. 1 is a perspective view illustrating a power supply device according to a first embodiment.

FIG. 2 is an exploded perspective view of the power supply device of FIG. 1.

FIG. 3 is an exploded perspective view of the battery module of FIG. 2.

FIG. 4 is an exploded perspective view of the power supply device in FIG. 2 as viewed obliquely from below.

FIG. 5 is a cross-sectional view taken along line V-V of the power supply device in FIG. 1.

FIG. 6 is a cross-sectional view taken along line VI-VI of the power supply device in FIG. 1.

FIG. 7 is a cross-sectional view illustrating a state in which the lid is deformed in the power supply device of FIG. 5.

FIG. 8 is an enlarged cross-sectional view illustrating a state in which the lid is detached from the state of FIG. 11.

FIG. 9 is an exploded perspective view illustrating a power supply device according to a comparative example.

FIG. 10 is a schematic diagram illustrating a state in which the label is peeled off by the pressure of gas in the power supply device of FIG. 9.

FIG. 11 is an enlarged perspective view of FIG. 2.

FIG. 12 is an enlarged perspective view of a main part of the cross-sectional view of FIG. 5.

FIG. 13 is an exploded perspective view of the cross-sectional view of FIG. 12.

FIG. 14 is a perspective view as seen obliquely from below of a state in which the gas outlet is closed by the lid.

FIG. 15 is an exploded perspective view in which the lid is removed from FIG. 14.

FIG. 16 is a cross-sectional view of FIG. 14.

FIG. 17 is an exploded perspective view in which the lid is removed from FIG. 15.

FIG. 18 is a perspective view of the lid as seen obliquely from below.

FIG. 19 is a perspective view of the lid as seen obliquely from below.

FIG. 20 is a bottom view of the lid.

FIG. 21 is a cross-sectional view showing the power supply device according to Embodiment 2.

### DESCRIPTION OF EMBODIMENT

The embodiment of the present disclosure may be specified by the following configurations and features.

In another aspect of the present disclosure, the power supply device is configured such that, in the above aspect, the step section is formed on the back surface of the lid to be smaller than the outer diameter of the lid, and the at least one locking piece includes a plurality of locking pieces provided around the gas outlet, and the plurality of locking pieces lock a plurality of locations around the step section. With the above configuration, the lid can be locked at a plurality of locations by the plurality of locking pieces, thereby enhancing the reliability of the engaged state.

In another aspect of the present disclosure, the power supply device is configured such that, in any of the above aspects, the elastic holding portion includes a wall forming a groove shape opened upward around the gas outlet, the at least one locking piece is formed from the wall to have spring properties in the inner and outer circumferential directions of the gas outlet, the lid includes a flat plate-shaped lid body and a flange having an outer diameter smaller than that of the lid body, the step section is formed between the lid body and the flange, the flange has an upper surface forming the step section, and the at least one locking piece has a hook that abuts against the upper surface of the flange and is locked to the upper surface of the flange. With the above configuration, the structure for holding the step section and locking the lid is continuously formed around the gas outlet to simplify the configuration, and the at least one locking piece is easily deformed during gas discharge, thereby improving the stability of the operation.

Further, in another aspect of the present disclosure, the power supply device is configured such that, in any of the above aspects, the lid forms a recess in a central portion of the flange. With the above configuration, when high-pressure gas is released, the gas is concentrated in the recess of the lid, and the center is deformed into a raised posture so that the center is easily deformed into a shape in which the engagement structure with the locking piece is easily disengaged, thereby improving the reliability of the operation of opening the gas outlet.

Further, in another aspect of the present disclosure, the power supply device is configured such that, in any of the above aspects, the lid is made of a plastically deformable member.

Further, in another aspect of the present disclosure, the power supply device is configured such that, in any of the above aspects, the gas outlet is opened in a circular shape.

Further, in another aspect of the present disclosure, the power supply device is configured such that, in any of the above aspects, the annular elastic body is a rubber O-ring.

Hereinafter, embodiments of the present disclosure will be described with reference to the drawings. However, the embodiments described below are merely examples for embodying the technical idea of the present disclosure, and the present disclosure is not limited thereto. Further, in this specification, the members shown in the claims are by no means limited to the members of the embodiments. In particular, unless otherwise specifically stated, the dimensions, materials, shapes, relative arrangements, etc. of the components described in the embodiments are not intended to limit the scope of the present disclosure to only those, but are merely illustrative examples. The sizes, positional relationships, and the like of the members shown in the drawings may be exaggerated for clarity of explanation. Further, in the following description, the same names and reference numerals indicate the same or similar members, and detailed descriptions thereof will be omitted as appropriate. Furthermore, each element constituting the present disclosure may be configured such that a plurality of elements are constituted by the same member and one member serves as a plurality of elements, or conversely, the function of one member may be shared and realized by a plurality of members.

The power supply device of the present disclosure can be used as a driving power source for a mobile body such as an electric cart, electric scooter, or assisted bicycle, as a power source for portable electric devices such as wireless devices, electric cleaners, or electric tools, in stationary power storage applications, as a backup power source for servers and as a power supply device for home use, business use, or factory use, or as a driving power source for vehicles such as hybrid vehicles or electric vehicles. Hereinafter, as one embodiment of the present invention, a power supply device used as a driving power source for an electric cart will be described.

### First Embodiment

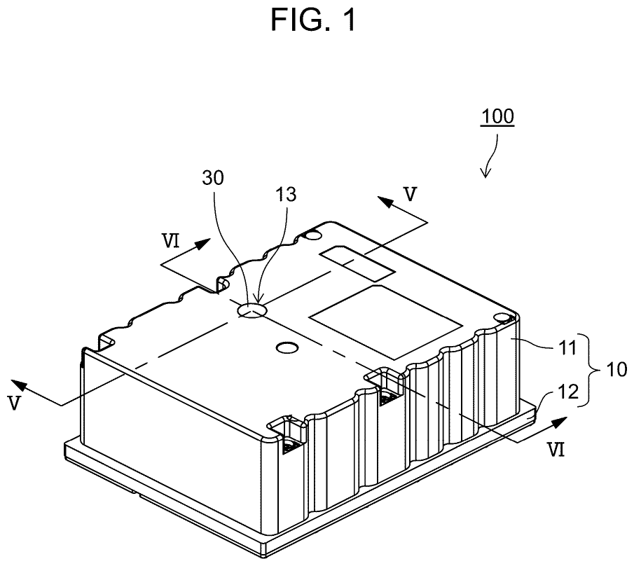

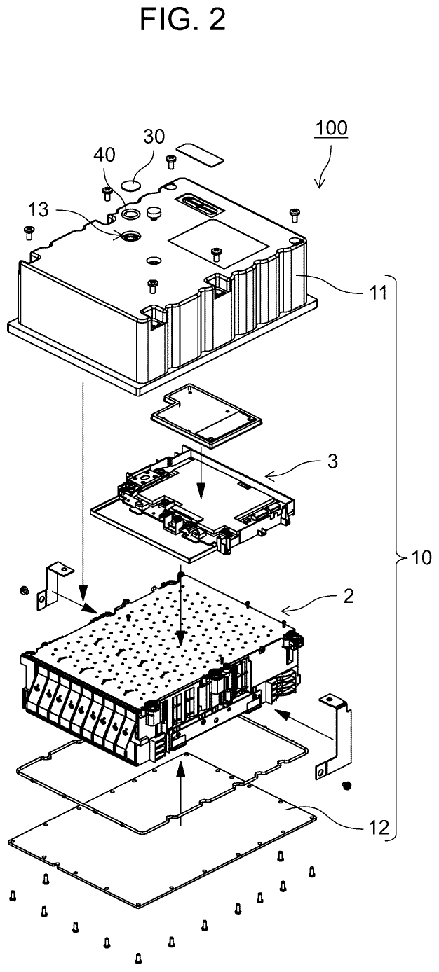

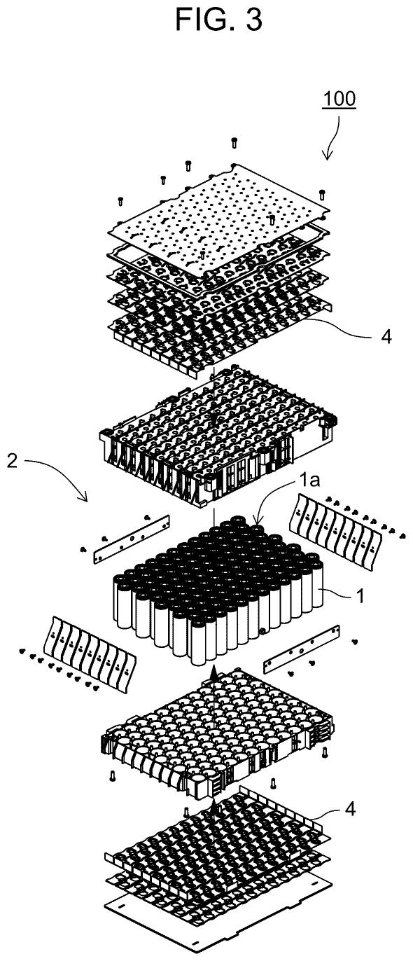

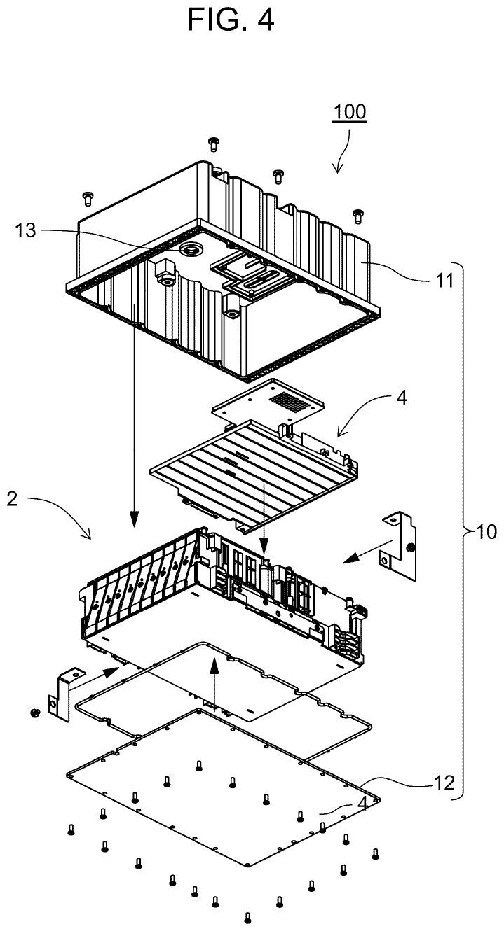

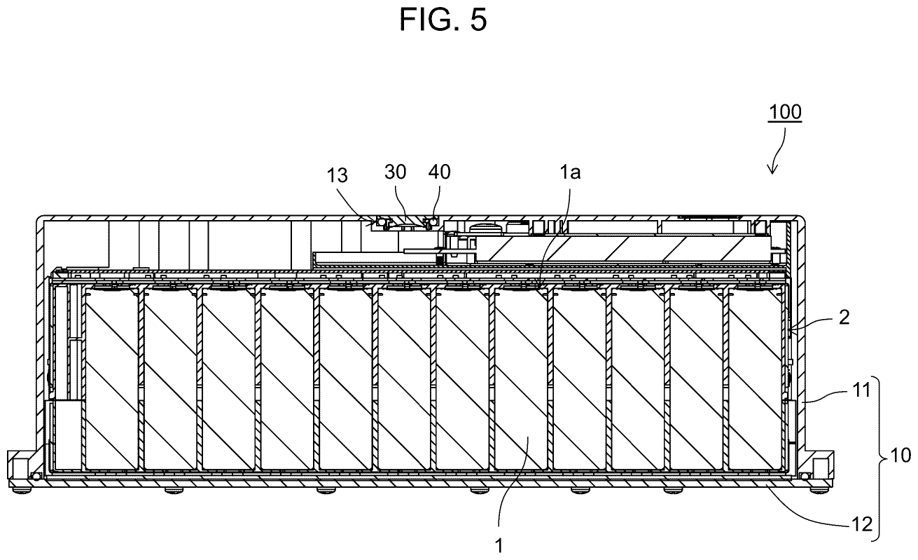

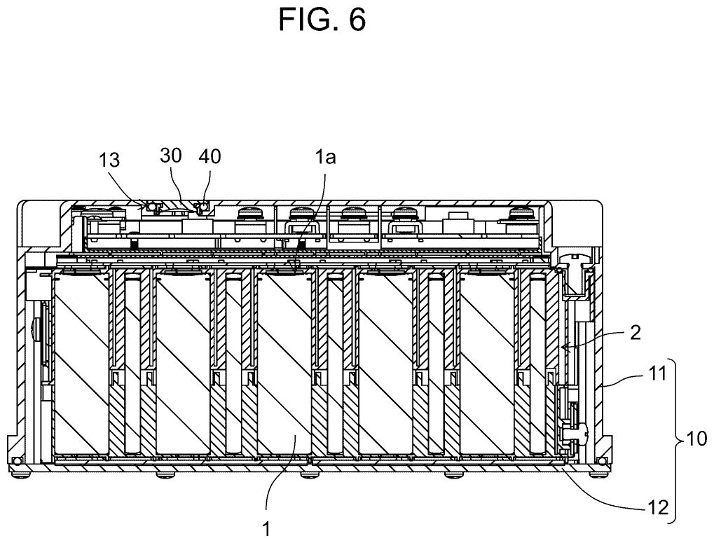

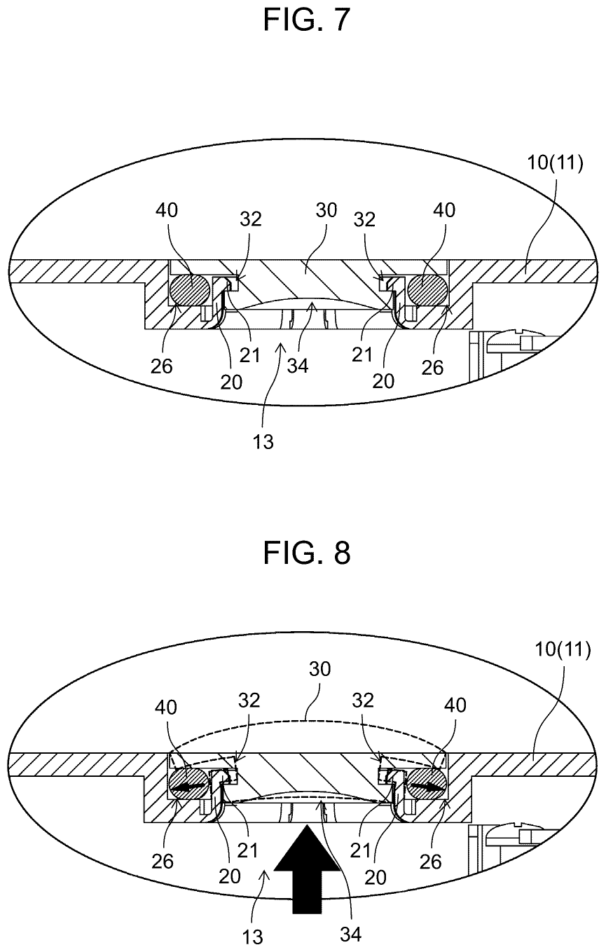

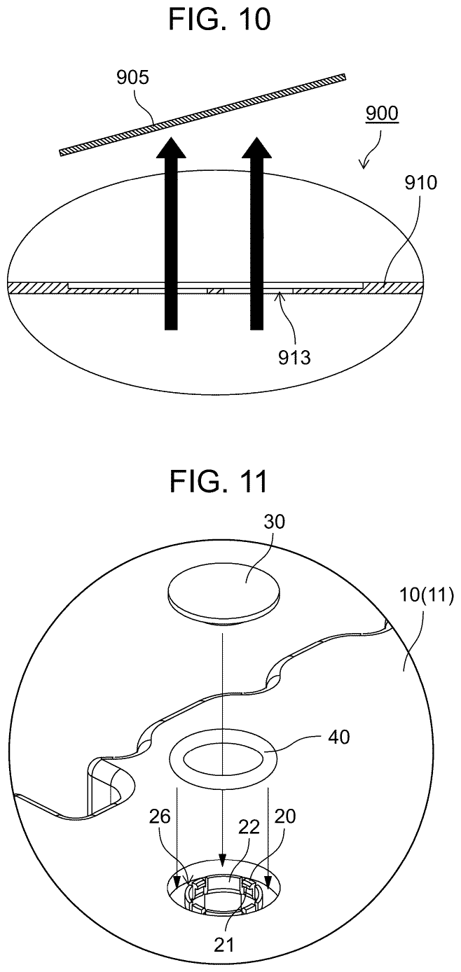

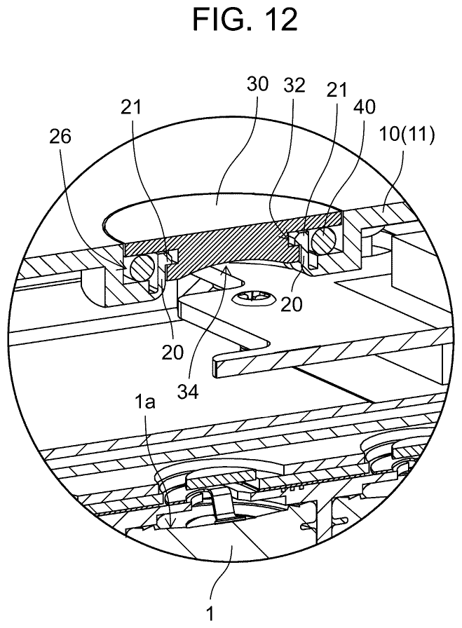

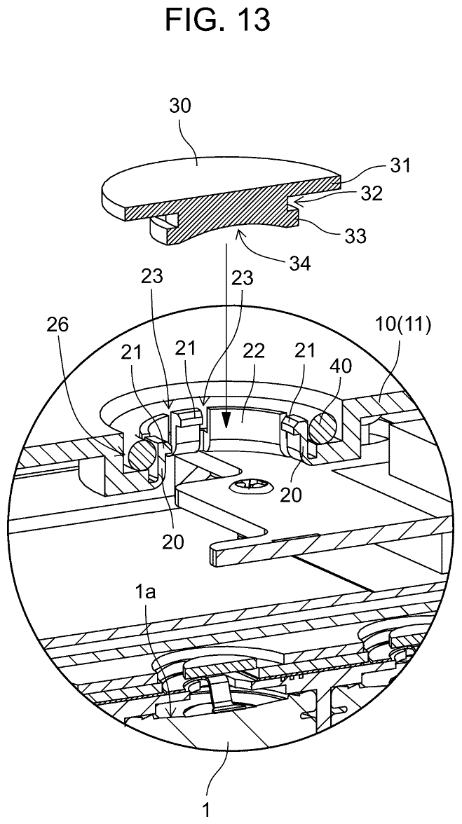

A power supply device 100 according to a first embodiment of the present disclosure is shown in FIGS. 1 to 13. In these drawings, FIG. 1 is a perspective view showing the power supply device 100 according to the first embodiment, FIG. 2 is an exploded perspective view of the power supply device 100 of FIG. 1, FIG. 3 is an exploded perspective view of the battery module 2 of FIG. 2, FIG. 4 is an exploded perspective view of the power supply device 100 of FIG. 2 as viewed obliquely from below, FIG. 5 is a sectional view of the power supply device 100 of FIG. 1 taken along line V-V, FIG. 6 is a sectional view of the power supply device 100 of FIG. 1 taken along line VI-VI, FIG. 7 is a sectional view showing a state in which the lid 30 is deformed in the power supply device 100 of FIG. 5, FIG. 8 is an enlarged sectional view showing a state in which the lid 30 is removed from the state of FIG. 11, FIG. 11 is an enlarged perspective view of FIG. 2, FIG. 12 is an enlarged perspective view of a main part of the sectional view of FIG. 5, and FIG. 13 is an exploded perspective view of the sectional view of FIG. 12. The power supply device 100 shown in these figures includes an exterior case 10 and a battery module 2.

### (Exterior Case 10)

The exterior case 10 accommodates the battery module 2 and the circuit board 3. The external shape of the exterior case 10 may be any shape having an internal storage space. In the example shown in FIGS. 1 to 6, the exterior case 10 is formed in a box shape extending in one direction. The box-shaped exterior case 10 is composed of a top surface and a bottom surface that are spaced apart vertically, and side surfaces connecting these surfaces.

As shown in FIGS. 2 to 4, for example, the exterior case 10 is divided into an upper case 11 and a lower case 12. The exterior case 10 is preferably made of a member having excellent insulating properties, such as a resin of polycarbonate or PC-ABS alloy, but may also be made of a metal member such as aluminum or an alloy thereof. Further, as shown in FIGS. 2 to 5, an internal space for housing the battery module 2 and the circuit board 3 is provided inside the exterior case 10.

### (Battery Module 2)

The battery module 2, also referred to as a core pack, houses a plurality of secondary battery cells 1. The battery module 2 may be composed of a plurality of battery blocks, and each battery block may house a plurality of secondary battery cells 1. In the example of FIG. 3, a large number of cylindrical secondary battery cells 1 are housed and held in a battery holder in a vertical orientation. The plurality of secondary battery cells 1 are connected in series or in parallel via the lead plate 4. The number of series connections and the number of parallel connections can be set arbitrarily according to the required specifications. In the example of FIGS. 3, 120 secondary battery cells 1 are used in the battery module 2 to form 10 series×12 parallel, but this configuration is not limited thereto.

The battery holder is provided with a plurality of storage tubes for individually housing the secondary battery cell 1. For example, each battery holder may be vertically divided into two parts, and the secondary battery cell 1 is housed so as to be sandwiched from above and below by the storage tubes divided in two. Such a battery holder can be made of a resin such as polycarbonate having excellent insulating properties.

### (Secondary Battery Cell 1)

Each secondary battery cell 1 may be a secondary battery cell having a cylindrical or prismatic outer shape. In the examples shown in FIGS. 3, 5, and 6, cylindrical secondary battery cells 1 are arranged in a zigzag manner in a vertical orientation. Note that the number and arrangement of secondary battery cells 1 are not limited to this example, and any number and arrangement may be adopted as appropriate. For example, cylindrical secondary battery cells may be arranged in a matrix.

Each secondary battery cell 1 has positive and negative electrodes. The positive and negative electrodes are preferably provided on one end face of the secondary battery cell 1. For the secondary battery cell 1, a known secondary battery such as a lithium-ion secondary battery, a nickel metal hydrogen battery, or a nickel cadmium battery can be appropriately used.

### (Gas Exhaust Valve 1a)

The outer can of each secondary battery cell 1 is provided with a gas exhaust valve 1a. The gas exhaust valve 1a opens in response to an increase in the internal pressure of the outer can, and releases gas inside the outer can to the outside. The positive electrode of the secondary battery cell 1 is provided with such a gas exhaust valve, for example, as illustrated in FIGS. 3, 5, and 6.

### (Gas Outlet 13)

On the other hand, the exterior case 10 is partially formed with a gas outlet 13 for releasing high-pressure gas to the outside when the gas exhaust valve 1a of the secondary battery cell 1 is opened and high-pressure gas is discharged. In the examples of FIGS. 2 and 3, the gas outlet 13 is provided near the center of the top surface of the exterior case 10. In these examples, the gas outlet 13 has a circular shape. The shape of the gas outlet 13 is not limited to a circular shape, and may be a polygonal shape such as an octagonal shape, a hexagonal shape, or a quadrangular shape, or an elliptical shape. However, from the viewpoint of stably performing the operation of releasing the blockage of the gas outlet, it is preferable for the gas outlet 13 to have a circular shape so that pressure is likely to be uniformly applied to the member that blocks the gas outlet.

### (Lead Plate 4)

Lead plates 4 are disposed on a side surface of the battery holder. Each lead plate 4 connects electrodes on end surfaces of the secondary battery cell 1 to each other to connect a plurality of secondary battery cells 1 in series or in parallel. In the example of FIG. 3, end faces of 90 secondary battery cells 1 are connected to each other by the lead plate 4, and the secondary battery cells 1 are connected in 10 series×12 parallel. Note that the number and arrangement of the secondary battery cells 1, the number of series and parallel connections are not limited to this example, and any number and arrangement can be appropriately adopted. Each lead plate 4 is made of a highly conductive metal plate such as an aluminum plate or a nickel plate.

### (Insulating Plate)

An insulating plate is disposed on an end surface of each lead plate 4. The insulating plate is formed in a size to cover the entire surface of each lead plate 4. An electrode window is partially opened so as to expose the electrode portion of each lead plate 4. These insulating plates are made of a material having excellent insulating properties and fire resistance, such as mica.

### (Circuit Board 3)

As illustrated in FIG. 2, the battery module 2 is connected to the circuit board 3 via the lead plates 4. The circuit board 3 includes a charge/discharge circuit that charges and discharges the secondary battery cell 1, a protection circuit that monitors a voltage and a temperature of the secondary battery cell 1 and cuts off a current in an abnormal case. The circuit board 3 is formed of a glass epoxy substrate. A substrate holder for holding such a circuit board 3 may be provided.

### (Lid 30)

The power supply device 100 also includes a member for closing the gas outlet 13. In the examples shown in FIGS. 2, 7, and 8, the gas outlet 13 is closed by the lid 30.

By forming the gas outlet 13 in the power supply device 100, in case where the gas exhaust valve 1a of the secondary battery cell 1 is opened and the internal pressure of the exterior case 10 increases, gas can be discharged to the outside through the gas outlet 13 to reduce the internal pressure, thereby improving safety. On the other hand, in order to avoid a situation in which water or the like intrudes into the power supply device and causes an unintended short circuit, it is necessary to keep the gas outlet 13 close under normal conditions.

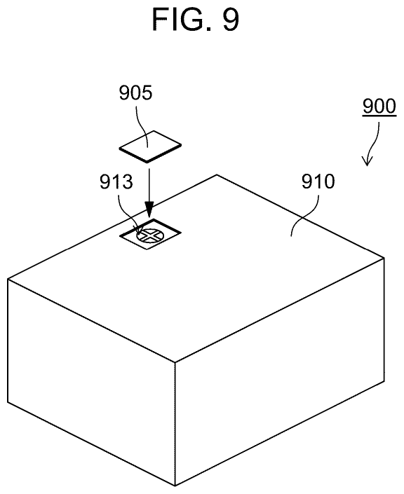

As a structure that closes the gas outlet under normal conditions and allows the gas outlet to be opened in an abnormal state, a label may be attached to the gas outlet. In the power supply device 900 according to the comparative example shown in FIG. 9, the label 905 is attached to the gas outlet 913 formed in the exterior case 910 to close the gas outlet 913 and thereby achieve waterproofness. In addition, when the pressure inside the exterior case 910 increases, as shown in FIG. 10, the label 905 is peeled off by the internal pressure, thereby opening the gas outlet 913.

In such a configuration in which a label is attached, in order to improve waterproofness, it is required to increase the adhesive force of the label. On the other hand, in order to reliably peel off the label when gas is released due to an abnormality in any of the secondary battery cells, it is required to weaken the adhesive force of the label. Thus, the label is required to have conflicting characteristics between ensuring the waterproofness of the power supply device and the stability of the opening operation at the time of gas discharge, and it has not been easy to achieve both. The adhesive force of the label depends on the adhesion area of the label, the material of the adhesive, and the adhesive force of the adhesive, but it is difficult to optimally design these factors, and even if the optimal value is set, differences may arise depending on the pressure applied by the worker to the adhesive surface of the label during attachment, making it difficult to ensure reliability.

On the other hand, in the power supply device 100 according to Embodiment 1, the lid 30 is locked and closed, rather than being attached by a label. Specifically, the exterior case 10 has a locking piece 20 for locking the lid 30. The lid 30 forms a step section 32 that engages with the locking piece 20. With such a configuration, as shown in FIG. 7, the locking piece 20 of the exterior case 10 is locked to the step section 32 of the lid 30, so that the lid 30 can close the gas outlet 13. On the other hand, if the gas exhaust valve 1a is opened in any of the secondary battery cells 1 and gas is discharged, the engagement of the locking piece 20 with the step section 32 is released as shown in FIG. 8. Specifically, the lid 30 is pressed in the direction indicated by the thick arrow from the inner surface of the gas outlet 13 due to an increase in the internal pressure inside the exterior case 10. The lid 30 is deformed into the shape indicated by the broken line by this pressing. As a result, the locking piece 20 expands in the direction indicated by the thin arrow in accordance with the deformation of the step section 32, and the engaged state is released. As a result, the lid 30 is separated from the gas outlet 13, the gas outlet 13 is opened, and high-pressure gas is discharged from the exterior case 10 to the outside through the gas outlet 13. According to this configuration, it is possible to avoid unstable events such as variations in the adhesive force of the label depending on the pressure applied during label attachment, and to obtain stable operation results regardless of variations in the operation of the worker.

The lid 30 is preferably made of an elastically deformable member. Preferably, the lid 30 is made of a resin such as polycarbonate. In this way, when the lid 30 receives high-pressure gas, the step section 32 and the locking piece 20 can be easily disengaged from each other by elastic deformation of the lid 30.

### (Elastic Body 40)

Further, by interposing the elastic body 40 between the lid 30 and the exterior case 10, waterproofness is improved. Specifically, as shown in FIG. 11, an elastically deformable annular elastic body 40 is interposed between the periphery of the gas outlet 13 and the lid 30. Elastomers, rubber can be used for the elastic body 40, and typically, an O-ring can be used.

The exterior case 10 forms an elastic holding portion 26 for holding the elastic body 40 around the gas outlet 13. In the example illustrated in FIG. 11, the elastic holding portion 26 is formed in a groove shape by a step obtained by lowering the periphery of the gas outlet 13 by one step on the upper surface of the exterior case 10 and a wall 22 formed to extend along the inner surface of the gas outlet 13 inside the step. With such a configuration, the gas outlet 13 can reliably exhibit a waterproof structure with respect to the outside of the exterior case 10 by using elastic deformation of the elastic body 40. When high-pressure gas is discharged from the gas exhaust valve 1a and the internal pressure of the exterior case 10 increases, the engagement between the exterior case 10 and the lid 30 is released. At this time, the configuration is such that the deformation of the locking piece 20 is not prevented by the elastic body 40. For example, the locking piece 20 and the elastic body 40 may be separated from each other, or the elastic body 40 may be made easily elastically deformable so that deformation of the locking piece 20 is not prevented even when the locking piece 20 comes into contact with the elastic body 40.

The elastic body 40 is preferably disposed outside the locking piece 20 so as to fill a gap between the lid 30 and the exterior case 10. In the examples illustrated in FIGS. 7, 11, and the like, the elastic body 40 is arranged so as to surround the plurality of locking pieces 20. For this reason, the inner diameter of the elastic body 40 is made larger than the outer diameter of the plurality of locking pieces 20 provided annularly. On the other hand, the elastic holding portion 26 is formed in a groove shape opened upward around the gas outlet 13. Here, the exterior case 10 forms a recess between the edge of the gas outlet 13 and the locking piece 20 so as to hold an annular elastic body 40 on the outside of the locking piece 20, forming an elastic holding portion 26 for holding the elastic body 40 therein.

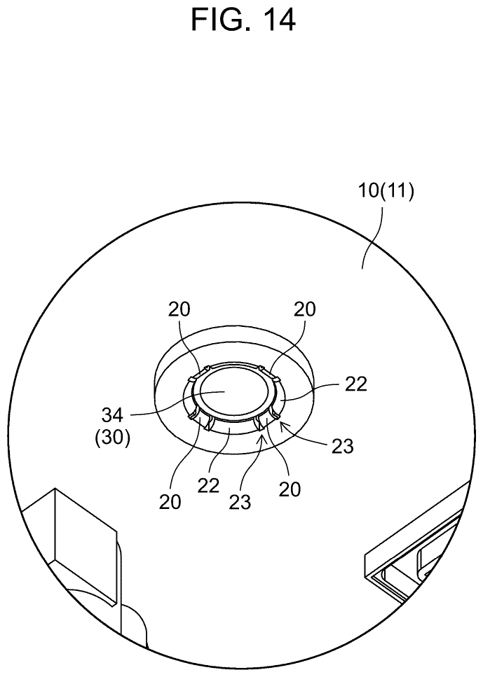

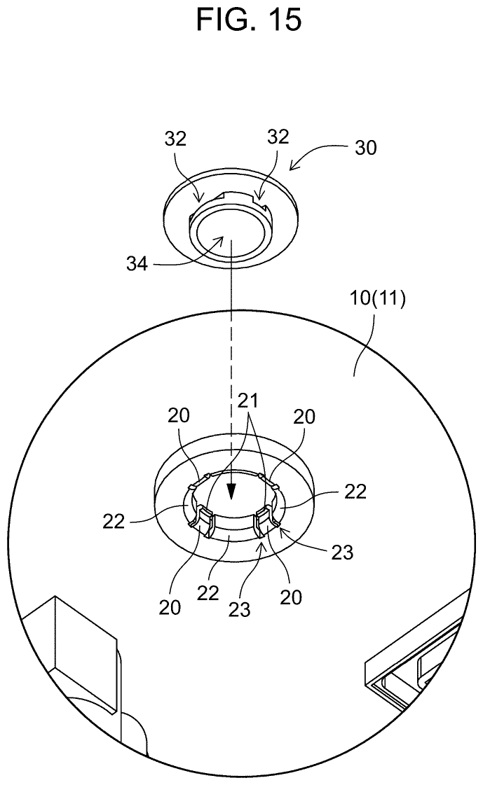

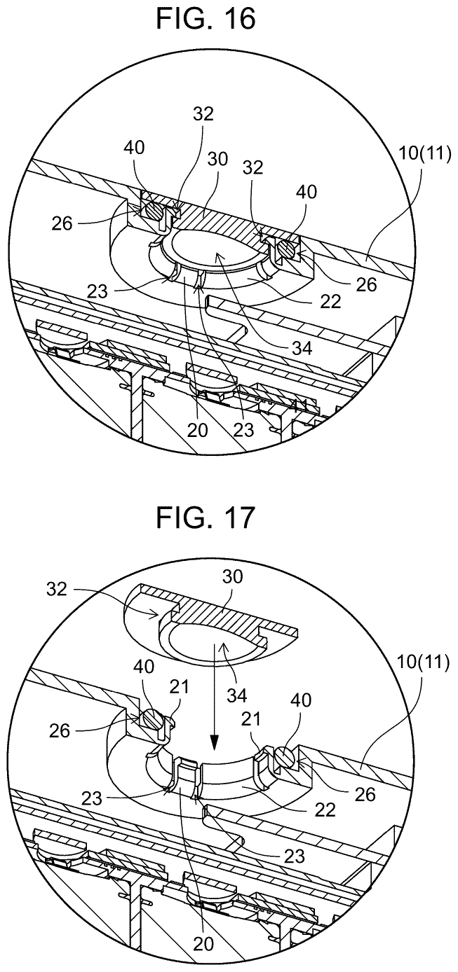

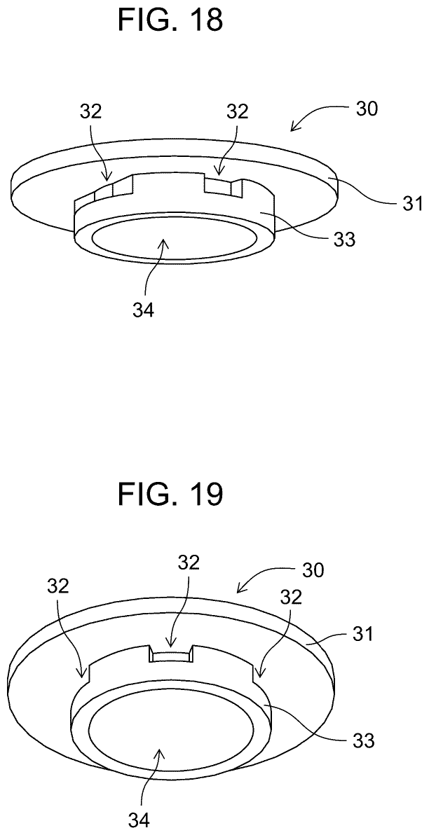

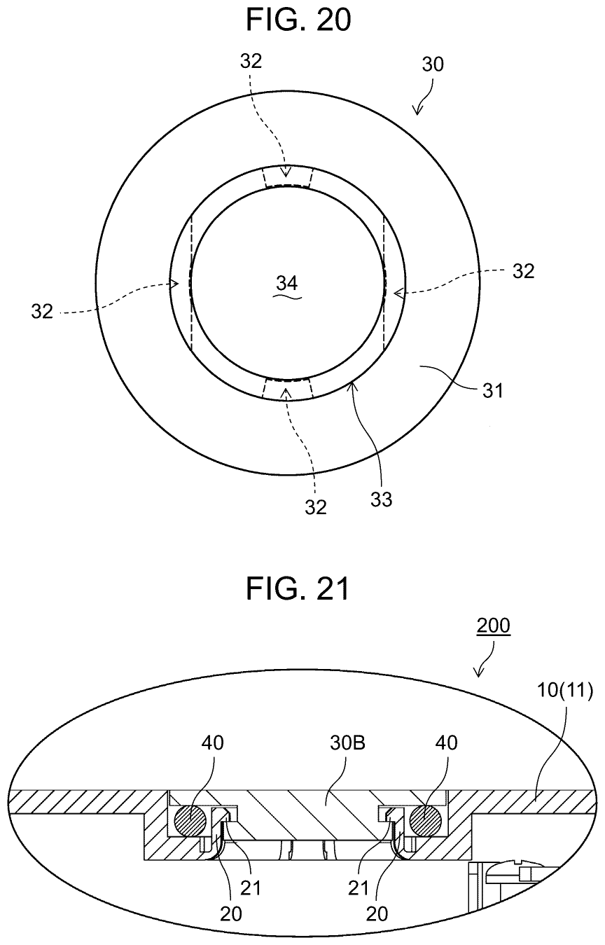

FIGS. 12 to 20 show the detailed structure for mounting the lid 30 to the exterior case 10. In these drawings, FIG. 12 is an enlarged perspective view of a main part of the sectional view of FIG. 5, FIG. 13 is an exploded perspective view of the sectional view of FIG. 12, FIG. 14 is a perspective view as seen obliquely from below of a state in which the gas outlet 13 is closed by the lid 30, FIG. 15 is an exploded perspective view in which the lid 30 is removed from FIG. 14, FIG. 16 is a sectional view of FIG. 14, FIG. 17 is an exploded perspective view in which the lid 30 is removed from FIG. 15, FIG. 18 is a perspective view of the lid 30 as seen obliquely from below, FIG. 19 is a perspective view of the lid 30 as seen obliquely from below, and FIG. 20 is a bottom view of the lid 30.

### (Locking Piece 20)

A plurality of locking pieces 20 are provided at a plurality of locations around the gas outlet 13. The plurality of locking pieces 20 lock the step section 32 at a plurality of positions around the step section 32, thereby increasing the reliability of the engagement state of the lid 30 with the gas outlet 13. In the examples shown in FIGS. 11, 14 to 17, four locking pieces 20 are provided at equal intervals (at 90° intervals) around the circular gas outlet 13. By arranging the four locking pieces 20 at equal intervals in this way, the lid 30 can be stably connected over the entire circumferential direction of the circular gas outlet 13. However, the number of locking pieces may be three or less, or five or more, depending on the required connection strength. Further, the plurality of locking pieces are not limited to being arranged at equal intervals, and may be arranged over the entire circumferential direction of the gas outlet 13.

Further, in the examples of FIGS. 11, 13, 15, and 17, the locking piece 20 is provided by partially forming the cutout 23 in the pipe-shaped wall 22 that is raised from the inner surface of the exterior case 10 at the gas outlet 13 opened in the upper case 11 of the exterior case 10. In this way, the locking piece 20 can be easily formed by forming the pipe-shaped wall 22 into a shape in which portions corresponding to both sides of the locking piece 20 are cut out. The locking piece 20, formed in a plate shape by cutting out both sides, can be elastically deformed and easily bent so as to open from the upper end.

Each locking piece 20 has a spring property in the inner and outer circumferential directions of the gas outlet 13 from the wall 22. Specifically, as shown in FIGS. 11, 13, and 17, each locking piece 20 has a hook 21 at its tip. The hook 21 protrudes toward the center of the gas outlet 13 at the tip of the locking piece 20. The hook 21 is locked to the step section 32 of the lid 30, whereby the lid 30 is coupled at a position where the gas outlet 13 of the exterior case 10 is closed. The lower surface of the hook 21 serves as a contact surface that contacts the step section 32 of the lid 30.

Note that, in the examples of FIGS. 11 to 17, the locking piece 20 is integrally formed with the exterior case 10, but the present disclosure is not limited to this configuration. For example, the locking piece may be configured as a separate member from the exterior case, and the locking piece may be fixed to the exterior case by a method such as adhesion.

As shown in FIGS. 18 to 20, the lid 30 includes a flat plate-shaped lid body 31 and a flange 33 having an outer diameter smaller than that of the lid body 31. The step section 32 is formed between the lid body 31 and the flange 33. The step section 32 is formed on the back surface side of the lid body 31 of the lid 30 such that the outer diameter of the step section 32 is smaller than the outer diameter of the flange 33. As shown in FIGS. 7 and 8, the step section 32 may be an annular groove formed on the outer peripheral surface of the lid body 31. The flange 33 has an upper surface that constitutes the step section 32. The contact surface of the locking piece 20 contacts the upper surface of the flange 33 constituting the step section 32, whereby the locking piece 20 is locked to the flange 33. With such a configuration, a structure for holding the step section 32 and locking the lid 30 is continuously formed around the gas outlet 13 to simplify the configuration, and the locking piece 20 is easily deformed at the time of gas discharge to improve the stability of the operation. Note that, in the example of FIG. 20, for easy demolding, in a plan view, the step section 32 is formed in a recess shape on the upper and lower sides and is formed flat on the left and right sides. However, the shape of each step section 32 is not limited to this example. For example, the left and right step sections 32 may also be formed in a recess shape.

The lid 30 also forms a recess 34 at the center of the flange 33. With such a shape, when high-pressure gas is discharged, the gas is concentrated in the recess 34 of the lid 30 as shown in FIG. 8, and the center is deformed into a raised posture, making it easier for the engagement structure with the locking piece 20 to be disengaged. As a result, the reliability of the operation of opening the gas outlet 13 is improved.

### Second Embodiment

However, the shape of the lid 30 is not limited to the above, and may be of another shape. For example, in the example of the power supply device 200 shown in the cross-sectional view of FIG. 21 as the power supply device according to the second embodiment, the bottom surface of the lid 30B is formed in a flat shape. If the pressure of the ejected gas is sufficiently high and the lid is stably opened at the time of gas ejection, such a shape may be employed.

Also, the lid may be configured to be ruptured by the pressure of the gas. For example, a slit may be provided in a part of the lid to make the lid easier to break, or the locking piece 20 that engages with the exterior case may be formed in a partially narrowed shape to make the locking piece 20 easier to break. In particular, since the stress required to break the resin is constant, while the bonding force of the label varies depending on the pressure applied by the worker, the lid is easier to design than the label.

As described above, by using the lid 30 instead of the label to close the gas outlet 13 and arranging the elastic body 40 around the lid 30, it is possible to quantitatively perform the opening operation of the gas outlet 13 at the time of gas release by the design of the locking structure, while maintaining waterproof performance regardless of the quality of the label attaching work. As a result, it is possible to provide a power supply device with stable quality and ensured safety, which does not depend on differences among workers during assembly work.

In the above example, the power supply device is attached to an electric device to be driven and supplies power to the electric device. When the remaining capacity of the power supply device decreases or when the power supply device deteriorates over time, the power supply device can be replaced and the electric device can continue to be used. However, the present invention is not limited to a replaceable type in which the power supply device mainly houses the secondary battery cell, and can also be applied to an aspect in which the secondary battery cell is housed in a housing of an electric device. In the present disclosure, it is sufficient for the power supply device to house the secondary battery cell in a case, and a power supply device also includes a configuration in which a secondary battery cell for driving is incorporated in a housing of an electric device itself. That is, the present invention is not limited to a replaceable power supply device, and can also be applied to an electric device having a built-in secondary battery cell.

### INDUSTRIAL APPLICABILITY

The power supply device according to the present disclosure can be suitably used as a power source for driving an assisted bicycle, a self-propelled robot for home delivery, an electric cart for home delivery or for golf courses, an electric scooter, a construction machine, or a vehicle such as a hybrid vehicle or an electric vehicle. The power supply device according to the present disclosure can also be appropriately used as a power source for portable electric devices such as a wireless device, an electric cleaner, or an electric tool. Further, the power supply device according to the present disclosure can be applied not only to a power supply device but also to a cooling mechanism of an electric device having a built-in heating element. Alternatively, The power supply device according to the present disclosure can be used for a stationary power storage device, for example, a power supply device for home use, business use, or factory use, or a backup power supply for a server.

### REFERENCE MARKS IN THE DRAWINGS

1 secondary battery cell
1a gas exhaust valve
2 battery module
3 circuit board
4 lead plate
10 exterior case
11 upper case
12 lower case
13 gas outlet
20 locking piece
21 hook
22 wall
23 cutout
26 elastic holding portion
30 lid
31 lid body
32 step section
33 flange
34 recess
40 elastic body
100 power supply device
200 power supply device
900 power supply device
905 label
910 exterior case
913 gas outlet

1. A power supply device comprising:
a plurality of secondary battery cells each including a gas exhaust valve configured to open in response to an increase in internal pressure of the secondary battery cell;
an exterior case which accommodates the plurality of secondary battery cells in the exterior case and includes a gas outlet opened for discharging gas released from the gas exhaust valve to outside of the exterior case;
a lid closing the gas outlet; and
an annular elastic body interposed between a periphery of the gas outlet and the lid,
wherein
the exterior case includes:
an elastic holding portion holding the annular elastic body around the gas outlet, and
at least one locking piece locking the lid,
the lid forms a step section engaging with the at least one locking piece,
the lid, by engagement between the step section and the at least one locking piece, presses the annular elastic body to elastically deform the annular elastic body and close the gas outlet in a waterproof state, and
when gas is discharged from the gas exhaust valve, the lid is pressed from an inner surface of the gas outlet by an increase in internal pressure in the exterior case, and the engagement between the step section and the at least one locking piece is released.

2. The power supply device according to claim 1, wherein
the step section is formed on a back surface of the lid to be smaller than an outer diameter of the lid,
the at least one locking piece includes a plurality of locking pieces provided around the gas outlet, and
the plurality of locking pieces lock a plurality of portions around the step section.

3. The power supply device according to claim 1, wherein
the elastic holding portion has a wall constituting a groove shape opened upward around the gas outlet,
the at least one locking piece has a spring property in inner and outer circumferential directions of the gas outlet from the wall,
the lid includes a flat plate-shaped lid body and a flange having an outer diameter smaller than an outer diameter of the lid body,
the step section is formed between the lid body and the flange,
the flange has an upper surface constituting the step section, and
the at least one locking piece has a hook abutting on the upper surface of the flange and locked to the upper surface of the flange.

4. The power supply device according to claim 3, wherein the lid forms a recess in a central portion of the flange.

5. The power supply device according to claim 1, wherein the lid is formed of a plastically deformable member.

6. The power supply device according to claim 1, wherein the gas outlet is opened in a circular shape.

7. The power supply device according to claim 1, wherein the annular elastic body is a rubber O-ring.
